(19) United States
(12) Patent Application Publication
(10) Pub. No.: US 2023/0312176 A1
(43) Pub. Date: Oct. 5, 2023

(54) Recipe Storage Organizer Device

(71) Applicants: Anna Coleman, Jacksonville, FL (US); Anthony Coleman, Jacksonville, FL (US)

(72) Inventors: Anna Coleman, Jacksonville, FL (US); Anthony Coleman, Jacksonville, FL (US)

(21) Appl. No.: 17/847,401

(22) Filed: Jun. 23, 2022

Related U.S. Application Data
(60) Provisional application No. 63/327,151, filed on Apr. 4, 2022.

(51) Int. Cl. B65D 25/04; B65D 25/28; B65D 43/16; A47J 47/04; A47J 47/08; A23L 5/10; G01F 19/00

(52) U.S. Cl. CPC B65D 25/04; B65D 25/2808; B65D 43/164; A47J 47/04; A47J 47/08; A23L 5/10; G01F 19/002; A23V 2002/00

(57) ABSTRACT

The present invention relates to a storage organizer device. The device is designed to provide users with a transparent storage and organization device for baking and cooking. Specifically, the storage organizer device is designed to enable users to prep and store their ingredients when cooking and/or baking. The device comprises a plurality of removable, transparent, and rectangular-shaped measuring cups, a tablespoon insert holder, and a base component to store and transport all the components in. Specifically, the plurality of measuring cups are stored in the clear carrier base with a hinged lid and side handles for easy transportation. Further, each of the measuring cups is marked with lines denoting measurements in cups, tablespoons, ounces and millimeters.

### CROSS-REFERENCE TO RELATED APPLICATION

The present application claims priority to, and the benefit of, U.S. Provisional Application No. 63/327,151, which was filed on Apr. 4, 2022 and is incorporated herein by reference in its entirety.

### FIELD OF THE INVENTION

The present invention relates generally to the field of storage and organization devices. More specifically, the present invention relates to an improved storage organizer device that provides users with a transparent storage and organization device for baking and cooking. Specifically, the device comprises a plurality of measuring cups and a base to store and transport all components. Accordingly, the present disclosure makes specific reference thereto. Nonetheless, it is to be appreciated that aspects of the present invention are also equally applicable to other like applications, devices and methods of manufacture.

### BACKGROUND

By way of background, users who cook and bake on a consistent basis typically use numerous measuring cups, spoons, and other equipment to measure and store wet and dry ingredients. Further, it is well known that the use of conventional measuring cups or the like can result in inaccuracies due to normal container movement, such as if the container is raised by hand for ease of viewing or such inaccuracies can occur if the container is sitting on a table, counter, or the like, due to errors in the line of sight. Furthermore, it is often that conventional measuring devices are used for mixing liquids, semi-liquids, solids or other materials and on numerous occasions spillage of the ingredients occurs as a result of improper holding or movement of the measuring device or of the means used with the measuring device for stirring or mixing. It is also known that a lot of time can be wasted in transferring ingredients from measuring devices to mixing, sifting, and/or shaking devices for those functions. Further, prep areas for baking and cooking can be incredibly disorganized due to the number of cups, spoons, etc., needed to measure out ingredients. Users may spend considerable time organizing their ingredients and be forced to complete additional messy cleanup once finished.

Therefore, a novel device that provides an improved measuring device by which a more accurate measurement can be obtained, and which can also be used as a mixer, sifter, and/or shaker is needed. Further, a device is needed which is inexpensive in construction, simple, effective in operation, and adaptable to many other uses. Finally, a device is needed that can be used for storing multiple measuring cups and/or spoons, thereby leaving the kitchen counters, worktables, and shelves in an uncluttered condition.

Therefore, there exists a long-felt need in the art for a storage organizer device that provides users with a transparent storage and organization device for baking and cooking. There is also a long-felt need in the art for a storage organizer device that features multiple internal storage compartments, tablespoons, and up to twelve plastic measuring cups for storing and organizing wet and dry ingredients. Further, there is a long-felt need in the art for a storage organizer device that enables users to prep and store their ingredients, utilizing a hinged cover to protect any ingredients stored within the system. Moreover, there is a long-felt need in the art for a device that includes measurement lines denoting cups, tablespoons, ounces, and millimeters to ensure any type of measurement for ingredients can be completed with the device. Further, there is a long-felt need in the art for a storage organizer device that saves extensive time and effort when baking and afterward, reducing the amount of cleanup needed. Finally, there is a long-felt need in the art for a storage organizer device that can be emptied, washed and reused as needed.

The subject matter disclosed and claimed herein, in one embodiment thereof, comprises a storage organizer device. The device is designed to provide users with a transparent storage and organization device for baking and cooking. Specifically, the storage organizer device is designed to enable users to prep and store their ingredients when cooking and/or baking. The device comprises a plurality of removable, transparent, and rectangular-shaped measuring cups, a tablespoon insert holder, and a base component to store and transport all the components in. Specifically, the plurality of measuring cups are stored in the clear carrier base with a hinged lid and side handles for easy transportation. Further, each of the measuring cups is marked with lines denoting measurements in cups, tablespoons, ounces, and millimeters. Additionally, the tablespoon insert holder can hold five, two tablespoon capacity cups.

In this manner, the storage organizer device of the present invention accomplishes all of the foregoing objectives and provides users with a device wherein users can store wet and dry ingredients within the device as needed to complete their prep work for a recipe. The device is designed that when the ingredients are needed, users can retrieve them from the device and pour them into their bowls and other dishware. The device can then be emptied, washed, and reused as needed.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a storage organizer device. The device is designed to provide users with a transparent storage and organization device for baking and cooking. Specifically, the storage organizer device is designed to enable users to prep and store their ingredients when cooking and/or baking. The device comprises a plurality of removable, transparent, and rectangular-shaped measuring cups, a tablespoon insert holder, and a base component to store and transport all the components in. Specifically, the plurality of measuring cups are stored in the clear carrier base with a hinged lid and side handles for easy transportation. Further, each of the measuring cups is marked with lines denoting measurements in cups, tablespoons, ounces, and millimeters.

In one embodiment, the plurality of measuring cups are typically rectangular in shape to easily fit within the base component, however the measuring cups can be any suitable shape as is known in the art, depending on the needs and/or wants of a user. Further, the measuring cups are typically manufactured of a transparent or translucent material, such that a user can visualize the contents, however any suitable material can be used for manufacture as is known in the art. In one embodiment, the measuring cups preferably comprise a handle mounted on one side, which is an integral part of the measuring cup, and a pouring spout or lip positioned on the other side of said measuring cup, which is also an integral part of the measuring cup, approximately diametrically opposite the handle, with suitable space between the handle and the pouring spout or lip for placement of the desired graduated scales, measurement increments, etc.

In one embodiment, each of the plurality of measuring cups is marked with measurement lines denoting measurements in cups, tablespoons, ounces, and millimeters, etc., or any other suitable measuring increments as is known in the art, depending on the needs and/or wants of a user. Specifically, in one embodiment, the device comprises a plurality of removable measuring cups which can be stored within the base component and removed during use. The plurality of removable measuring cups comprise one 4-cup capacity measuring cup, six 2-cup capacity cups, and five 2-tablespoon capacity shot cups. However, any other suitable sizes and/or number of measuring cups can be utilized, as is known in the art depending on the needs and/or wants of a user.

In one embodiment, the storage organizer device comprises a tablespoon insert holder. The tablespoon insert holder typically holds five, 2-tablespoon capacity shot cups, or any other suitable number and size of tablespoons as is known in the art. Further, the tablespoon insert holder comprises a removable stand with legs for retaining the tablespoons and/or shot cups. The tablespoon insert holder can be removed when needed and placed on a kitchen counter or workspace for ease in utilizing the tablespoons and/or measuring cups stored within. The tablespoon insert holder can be any suitable size as is known in the art, depending on the needs and/or wants of a user, and depending on the number of tablespoons and/or measuring cups need to be stored within.

In another embodiment, the storage organizer device comprises a base component for transporting and storing the plurality of measuring cups and the tablespoon insert holder. The base component is typically manufactured of a transparent or translucent material, such that a user can visualize the contents of the base component, however any suitable material can be used for manufacture as is known in the art. Typically, the base component can be composed of any suitable rigid or flexible material, as long as the material is transparent/translucent. As stated supra, the transparent material would aid a user, such that the measuring cups or containers may be seen without opening the base component. In this way, the user can determine the identity and quantity of the contents of each measuring cup/container without having to open the base component or remove any measuring cups/containers.

In another embodiment, the base component comprises a rectangular shape with raised sidewalls forming a cavity, allowing for the plurality of measuring cups and the tablespoon insert holder to be placed inside. Typically, the base component comprises two sets of raised opposing sidewalls forming the rectangular-shaped structure for ease of storage of the measuring cups and tablespoon insert holder. However, the base component can be any suitable shape as is known in the art, depending on the needs and/or wants of a user.

In one embodiment, the plurality of measuring cups are retained in an organized arrangement inside the base component via a securing or holding means. Specifically, the holding means would be dimensioned to clamp or grasp the sides of the measuring cups, such that the measuring cups can be easily engaged or “snapped” into place, and alternately removed for use. It will be appreciated that many different kinds of securing or holding means may be used to organize the measuring cups, as is known in the art.

In another embodiment, the base component comprises an interior which is partitioned into a plurality of spaces by means of a partition matrix. The partition matrix may be removably fitted into the base component or permanently molded to the interior of the base component. The partition matrix may be formed by a plurality of partition plates, wherein each compartment is sized to accommodate a measuring cup of varying size and shape. The compartments may conform to fit a rectangular 4-cup, 2-cup, and/or 2-tablespoon capacity measuring cup or shot cup or may accommodate a container or measuring cup of a different size and/or shape. In this embodiment, the container can also comprise a lid, visible from the top of the base compartment. The lids can be labeled, such that a user can readily identify the contents of the container or measuring cup.

Further, the base component comprises a cover or lid. Typically, the cover or lid is a flat cover having a rectangular shape corresponding to the upper periphery of the base component's raised sidewalls. The cover is secured to one length of the sidewalls, such that the cover can be pivoted up and down (i.e., open and closed). Typically, the cover is secured via hinges, but can be secured via a living hinge, screws, bolts, etc., or any other suitable securing means as is known in the art, to the raised sidewall. Typically, the lid is secured to only one sidewall, to allow for opening and closing of the lid. Further, the lid can be secured to the base component via a friction fit, or any other holding means, such as mechanical fasteners, etc., to prevent the lid from coming off when the device is being used and to preserve the contents of the base component. Typically, the cover is solid to protect the ingredients and the containers stored within but can be any suitable design and can include mesh, screen, or multiple perforations.

In one embodiment, the base component comprises a pair of handles secured to the sidewalls for transporting the base component. The pair of handles can be any suitable size and shape, depending on the needs and/or wants of a user. The pair of handles are secured to the sidewalls using any suitable securing means as is known in the art, such as glue, bolts, screws, etc. Typically, one handle is secured to a sidewall and the second handle is secured to the opposing sidewall. Any suitable number of handles can be utilized as is known in the art, depending on the needs and/or wants of a user.

In another embodiment, the storage organizer device comprises a plurality of indicia on the measuring cups, the tablespoon insert holder and/or the base component.

In yet another embodiment, the storage organizer device, including the plurality of measuring cups, the tablespoon insert holder, and the base component and its lid, may be manufactured of the same material or different materials, depending on the needs and/or wants of a user. The material can be any suitable material as is known in the art, such as sheet metal, aluminum, special glasses or plastics, etc. However, it is suggested that a transparent or translucent material be used instead of opaque material for ease of reading the graduated scales and other measurement increments against the container contents. Further, the storage organizer device is also manufactured from a material that is water resistant or water permeable, or comprises a coating that is water resistant or water permeable.

In yet another embodiment, a method of storing and organizing wet and dry ingredients is described. The method includes the steps of utilizing a storage organizer device comprising a clear, carrier base with a hinged lid and side handles for transporting a plurality of measuring cups stored within. The method also comprises inserting the desired wet or dry ingredients into the storage organizer device. Further, the method comprises measuring out the desired wet or dry ingredients from the storage organizer device when needed, wherein the desired ingredients are measured out via the plurality of measuring cups and/or tablespoons. The method also comprises pouring the desired ingredients from the measuring cups and/or tablespoons into bowls or other dishware for use. Further, the method comprises baking or cooking with the ingredients. Finally, emptying, washing, and reusing the storage organizer device as needed.

In yet another embodiment of the present invention, a storage organizer device is disclosed for providing users with a transparent storage and organization device for baking and cooking. Specifically, the storage organizer device is designed to enable users to prep and store their ingredients when cooking and/or baking. The device comprises a plurality of removable, transparent, and rectangular-shaped measuring cups, a tablespoon insert holder, and a base component to store and transport all the components in. Specifically, the plurality of measuring cups are stored in the clear carrier base with a hinged lid and side handles for easy transportation. Further, each of the measuring cups is marked with lines denoting measurements in cups, tablespoons, ounces, and millimeters. Thus, the storage organizer device provides users with a device wherein users can store wet and dry ingredients within the device as needed to complete their prep work for a recipe. The device is designed that when the ingredients are needed, users can retrieve them from the device and pour them into their bowls and other dishware. The device can then be emptied, washed, and reused as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the storage organizer device of the present invention with the lid open in accordance with the disclosed architecture;

FIG. 2 illustrates a perspective view of another potential embodiment of the storage organizer device of the present invention in accordance with the disclosed architecture;

FIG. 3 illustrates a perspective view of the measurement increments on the measuring cups of one potential embodiment of the storage organizer device in accordance with the disclosed architecture;

FIG. 4 illustrates a perspective view showing how dry and wet ingredients can be stored within one potential embodiment of the storage organizer device of the present invention in accordance with the disclosed architecture;

FIG. 5 illustrates a perspective view of one potential embodiment of the storage organizer device of the present invention in use in accordance with the disclosed architecture; and

FIG. 6 illustrates a flowchart showing the method of storing and organizing wet and dry ingredients in one potential embodiment of the storage organizer device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a storage organizer device that provides users with a transparent storage and organization device for baking and cooking. There is also a long-felt need in the art for a storage organizer device that features multiple internal storage compartments, tablespoons, and up to 12 plastic measuring cups for storing and organizing wet and dry ingredients. Further, there is a long-felt need in the art for a storage organizer device that enables users to prep and store their ingredients, utilizing a hinged cover to protect any ingredients stored within the system. Moreover, there is a long-felt need in the art for a device that includes measurement lines denoting cups, tablespoons, ounces, and millimeters to ensure any type of measurement for ingredients can be completed with the device. Further, there is a long-felt need in the art for a storage organizer device that saves extensive time and effort when baking and afterward, reducing the amount of cleanup needed. Finally, there is a long-felt need in the art for a storage organizer device that can be emptied, washed and reused as needed.

The present invention, in one exemplary embodiment, is a novel storage organizer device. The device comprises a plurality of removable, transparent, and rectangular-shaped measuring cups, a tablespoon insert holder, and a base component to store and transport all the components in. Specifically, the plurality of measuring cups are stored in the clear carrier base with a hinged lid and side handles for easy transportation. Further, each of the measuring cups is marked with lines denoting measurements in cups, tablespoons, ounces, and millimeters. The present invention also includes a novel method of storing and organizing wet and dry ingredients. The method includes the steps of utilizing a storage organizer device comprising a clear carrier base with a hinged lid and side handles for transporting a plurality of measuring cups stored within. The method also comprises inserting the desired wet or dry ingredients into the storage organizer device. Further, the method comprises measuring out the desired wet or dry ingredients from the storage organizer device when needed, wherein the desired ingredients are measured out via the plurality of measuring cups and/or tablespoons. The method also comprises pouring the desired ingredients from the measuring cups and/or tablespoons into bowls or other dishware for use. Further, the method comprises baking or cooking with the ingredients. Finally, emptying, washing, and reusing the storage organizer device as needed.

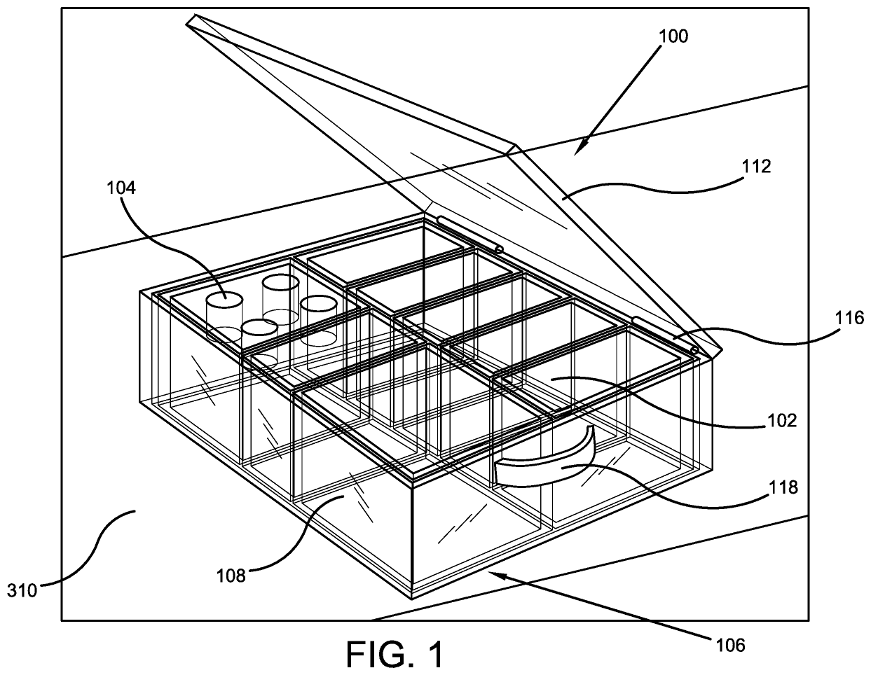

Referring initially to the drawings, FIG. 1 illustrates a perspective view of one embodiment of the storage organizer device 100 of the present invention. In the present embodiment, the storage organizer device 100 is an improved storage organizer device that allows users to store and organize wet and dry ingredients while cooking or baking. The device 100 is especially designed to allow any professional or amateur baker, chef, sous chef, etc., or any other suitable user as is known in the art, to save time and effort when baking or cooking, and reducing the amount of cleanup needed. More specifically, the device 100 comprises a plurality of removable, transparent, and rectangular-shaped measuring cups 102, a tablespoon insert holder 104, and a base component 106 to store and transport all components 102 and 104 in. Thus, the measuring cups 102 and tablespoon insert holder 104 are stored within the base component 106 for easy transportation.

In one embodiment, the base component 106 comprises a rectangular shape with raised sidewalls 108 forming a cavity 110, allowing for the plurality of measuring cups 102 and the tablespoon insert holder 104 to be placed inside. Typically, the base component 106 comprises two sets of raised, opposing sidewalls 108 forming the rectangular-shaped structure, for ease of storage of the measuring cups 102 and tablespoon insert holder 104. However, the base component 106 can be any suitable shape as is known in the art, depending on the needs and/or wants of a user.

In another embodiment, the base component 106 comprises a cover or lid 112. Typically, the cover or lid 112 is a flat cover having a rectangular shape corresponding to the upper periphery 114 of the base component's raised sidewalls 108. The cover 112 is secured to one length of the sidewalls 108, such that the cover 112 can be pivoted up and down (i.e., open and closed). Typically, the cover 112 is secured via hinges 116, but can be secured via a living hinge, screws, bolts, etc., or any other suitable securing means as is known in the art, to the raised sidewall 108. Typically, the lid 112 is secured to only one sidewall 108, to allow for opening and closing of the lid 112. Further, the lid 112 can be secured to the base component 106 via a friction fit, or any other holding means, such as mechanical fasteners, etc., to prevent the lid 112 from coming off when the device 100 is being used and to preserve the contents of the base component 106. Typically, the cover 112 is solid to protect the ingredients and the containers stored within but can be any suitable design and can include mesh, screen, or multiple perforations, etc.

Furthermore, in this embodiment, the base component 106 comprises a pair of handles 118 secured to the sidewalls 108 for transporting the base component 106. The pair of handles 118 can be any suitable size and shape, depending on the needs and/or wants of a user. The pair of handles 118 are secured to the sidewalls 108 using any suitable securing means as is known in the art, such as glue, bolts, screws, etc. Typically, one handle 118 is secured to a sidewall 108 and the second handle 118 is secured to the opposing sidewall 108. Any suitable number of handles 118 can be utilized as is known in the art, depending on the needs and/or wants of a user.

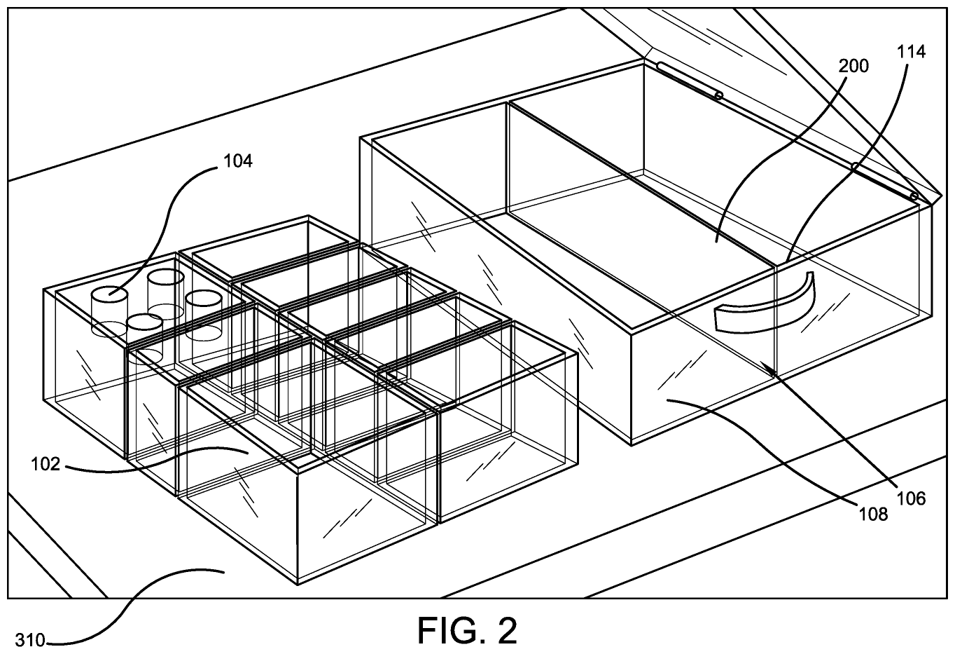

FIG. 2 illustrates a perspective view of another embodiment of the storage organizer device 100 of the present invention. In this embodiment, the storage organizer device 100 comprises a base component 106 for transporting and storing the plurality of measuring cups 102 and the tablespoon insert holder 104. The base component 106 is typically manufactured of a transparent or translucent material, such that a user can visualize the contents of the base component 106, however any suitable material can be used for manufacture as is known in the art. Typically, the base component 106 can be composed of any suitable rigid or flexible material, as long as, the material is transparent/translucent. As stated supra, the transparent material would aid a user, such that the measuring cups 102 or containers may be seen without opening the base component 106. In this way, the user can determine the identity and quantity of the contents of each measuring cup/container 102 without having to open the base component 106 or remove any measuring cups/containers 102.

In another embodiment, the plurality of measuring cups 102 are retained in an organized arrangement inside the base component 106 via a securing or holding means. Specifically, the holding means would be dimensioned to clamp or grasp the sides of the measuring cups 102, such that the measuring cups 102 can be easily engaged or “snapped” into place, and alternately removed for use. It will be appreciated that many different kinds of securing or holding means may be used to organize the measuring cups 102, as is known in the art.

In a different embodiment, the base component 106 comprises an interior which is partitioned into a plurality of spaces by means of a partition matrix 200. The partition matrix 200 may be removably fitted into the base component 106 or permanently molded to the interior of the base component 106. The partition matrix 200 may be formed by a plurality of partition plates, wherein each compartment is sized to accommodate a measuring cup 102 of varying size and shape. The compartments may conform to fit a rectangular 4-cup, 2-cup, and/or 2-tablespoon capacity measuring cup 102 or shot cup or may accommodate a container or measuring cup 102 of a different size and/or shape. In this embodiment, the container can also comprise a lid, visible from the top of the base compartment 106. The lids can be labeled, such that a user can readily identify the contents of the container or measuring cup 102.

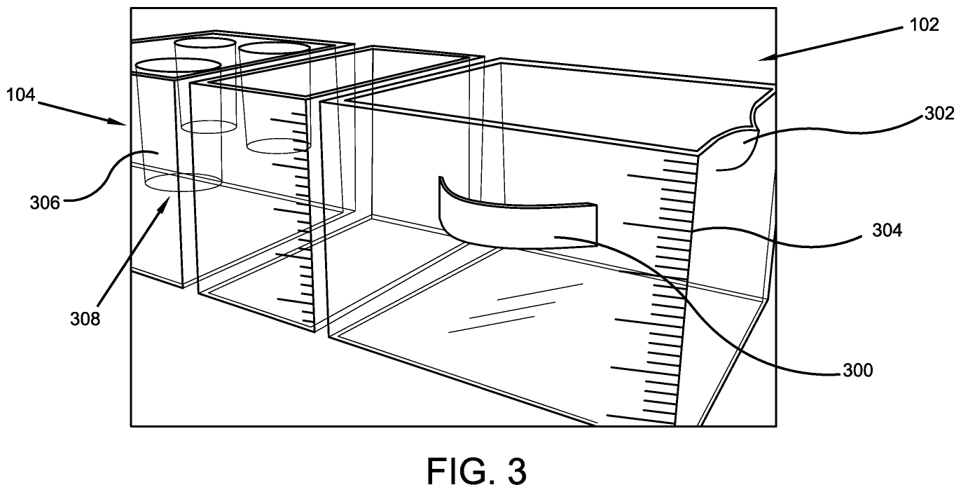

FIG. 3 illustrates a perspective view of another embodiment of the storage organizer device 100 of the present invention disclosing the measuring cups 102. In this embodiment, the plurality of measuring cups 102 are typically rectangular in shape to easily fit within the base component 106, however the measuring cups 102 can be any suitable shape as is known in the art, depending on the needs and/or wants of a user. Further, the measuring cups 102 are typically manufactured of a transparent or translucent material, such that a user can visualize the contents, however any suitable material can be used for manufacture as is known in the art. In one embodiment, the measuring cups 102 preferably comprise a handle 300 mounted on one side, which is an integral part of the measuring cup 102, and a pouring spout or lip 302 positioned on the other side of said measuring cup 102, which is also an integral part of the measuring cup 102, approximately diametrically opposite the handle 300, with suitable space between the handle 300 and the pouring spout or lip 302 for placement of the desired graduated scales, measurement increments 304, etc. The handle 300 can be configured as a notch or indentation for a user to place their hand and grab the measuring cup 102. In another embodiment, a pair of handles 300 are secured on opposing sides of the rectangular measuring cup 102. The pair of handles 300 are configured as notches or indentations for a user to place their hands and grab the measuring cup 102.

In another embodiment, each of the plurality of measuring cups 102 is marked with measurement lines 304 denoting measurements in cups, tablespoons, ounces, and millimeters, etc., or any other suitable measuring increments 304 as is known in the art, depending on the needs and/or wants of a user. Specifically, in one embodiment, the device 100 comprises a plurality of removable measuring cups 102 which can be stored within the base component 106 and removed during use. The plurality of removable measuring cups 102 comprise one 4-cup capacity measuring cup, six 2-cup capacity cups, and five 2-tablespoon capacity shot cups. However, any other suitable sizes and/or amounts of measuring cups 102 can be utilized, as is known in the art depending on the needs and/or wants of a user.

In another embodiment, the storage organizer device 100 comprises a tablespoon insert holder 104. The tablespoon insert holder 104 typically holds five 2-tablespoon capacity shot cups, or any other suitable amount and size of tablespoons as is known in the art. Further, the tablespoon insert holder 104 comprises a removable stand 306 with legs 308 for retaining the tablespoons and/or shot cups (not shown). The tablespoon insert holder 104 can be removed when needed and placed on a kitchen counter 310 or workspace for ease in utilizing the tablespoons and/or measuring cups stored within. The tablespoon insert holder 104 can be any suitable size as is known in the art, depending on the needs and/or wants of a user, and depending on the number of tablespoons and/or measuring cups 102 need to be stored within.

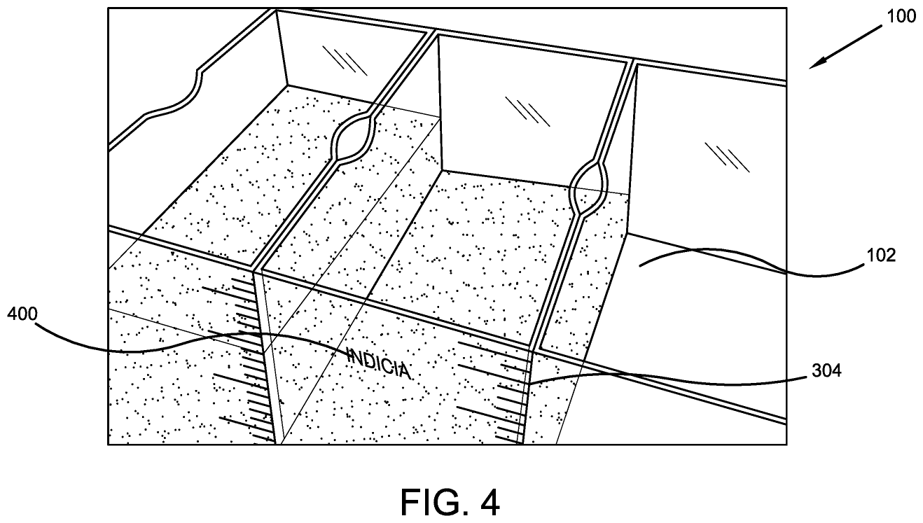

FIG. 4 illustrates a perspective view of another embodiment of the storage organizer device 100 of the present invention storing dry and wet ingredients. In this embodiment, the storage organizer device 100 comprises a plurality of indicia 400 on the measuring cups 102, the tablespoon insert holder 104 and/or the base component 106. The tablespoon insert holder 104 and/or the base component 106 may include advertising, a trademark, or other letters, designs, or characters, printed, painted, stamped, or integrated into the storage organizer device 100, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be cooking or baking/brand related.

Further, the storage organizer device 100, including the plurality of measuring cups 102, the tablespoon insert holder 104, and the base component 106 and its lid 112, may be manufactured of the same material or different materials, depending on the needs and/or wants of a user. The material can be any suitable material as is known in the art, such as sheet metal, aluminum, special glass or thermoplastics, such as, polyethylene, polyethylene terephthalate, polyvinyl chloride, polypropylene, acrylonitrile-butadiene-styrene (ABS), acrylic, polycarbonate, etc. However, it is suggested that a transparent or translucent material be used instead of opaque material for ease of reading the graduated scales and other measurement increments 304 against the container contents. Further, the storage organizer device 100 is also manufactured from a material that is water resistant or water permeable, or comprises a coating that is water resistant or water permeable.

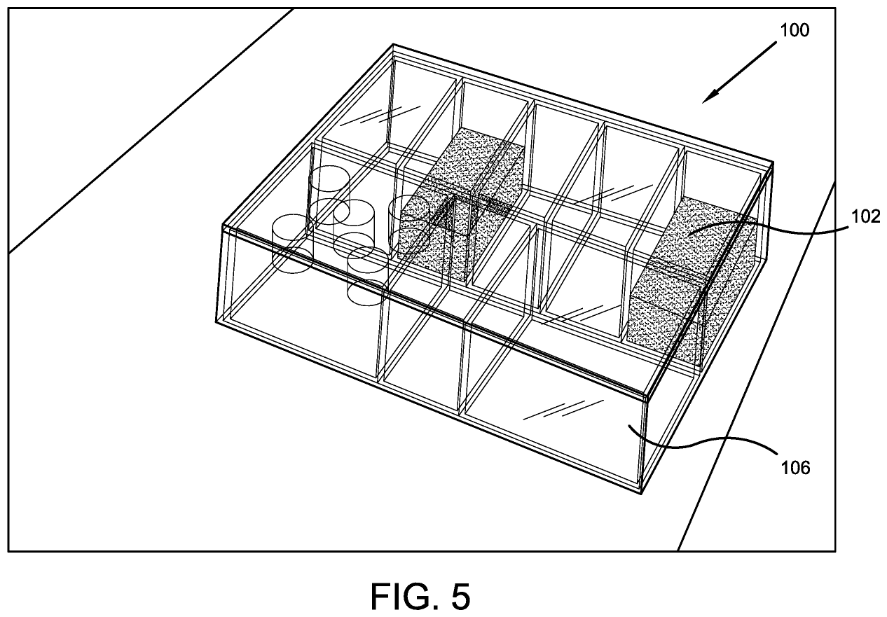

FIG. 5 illustrates a perspective view of another embodiment of the storage organizer device 100 of the present invention in use. In this embodiment, the storage organizer device 100 is disclosed for providing users with a transparent storage and organization device for baking and cooking. Specifically, the storage organizer device 100 is designed to enable users to prep and store their ingredients when cooking and/or baking. The device 100 comprises a plurality of removable, transparent, and rectangular-shaped measuring cups 102, a tablespoon insert holder 104, and a base component 106 to store and transport all the components in. Specifically, the plurality of measuring cups 102 are stored in the clear carrier base component 106 with a hinged lid 112 and side handles 118 for easy transportation. Further, each of the measuring cups 102 is marked with lines 304 denoting measurements in cups, tablespoons, ounces, and millimeters. Thus, the storage organizer device 100 provides users with a device 100 wherein users can store wet and dry ingredients within the device 100 as needed to complete their prep work for a recipe. The device 100 is designed that when the ingredients are needed, users can retrieve them from the device 100 and pour them into their bowls and other dishware. The device 100 can then be emptied, washed, and reused as needed.

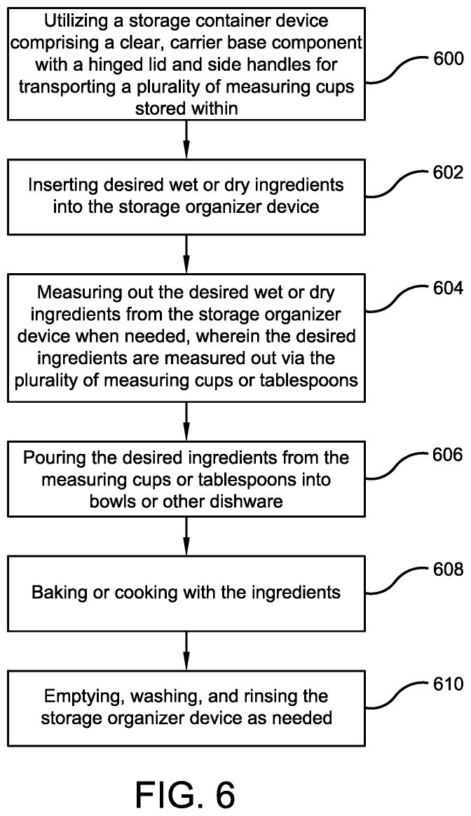

FIG. 6 illustrates a flowchart of the method of storing and organizing wet and dry ingredients. The method includes the steps of at 600, utilizing a storage organizer device comprising a clear carrier base with a hinged lid and side handles for transporting a plurality of measuring cups stored within. The method also comprises at 602, inserting the desired wet or dry ingredients into the storage organizer device. Further, the method comprises at 604, measuring out the desired wet or dry ingredients from the storage organizer device when needed, wherein the desired ingredients are measured out via the plurality of measuring cups and/or tablespoons. The method also comprises at 606, pouring the desired ingredients from the measuring cups and/or tablespoons into bowls or other dishware for use. Further, the method comprises at 608, baking or cooking with the ingredients. Finally, at 610, emptying, washing, and reusing the storage organizer device as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “storage organizer device” and “device” are interchangeable and refer to the storage organizer device 100 of the present invention.

Notwithstanding the foregoing, the storage organizer device 100 of the present invention can be of any suitable size and configuration as is known in the art without affecting the overall concept of the invention, provided that it accomplishes the above-stated objectives. One of ordinary skill in the art will appreciate that the storage organizer device 100 as shown in FIGS. 1-6 is for illustrative purposes only, and that many other sizes and shapes of the storage organizer device 100 are well within the scope of the present disclosure. Although the dimensions of the storage organizer device 100 are important design parameters for user convenience, the storage organizer device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A storage organizer device for storing and organizing a plurality of wet and dry ingredients while cooking or baking, the storage organizer device comprising:
a plurality of measuring cups; and
a base component for storing and transporting the plurality of measuring cups;
wherein the base component comprises a rectangular shape with raised sidewalls forming a cavity; and
wherein the base component further comprises an interior which is partitioned into a plurality of spaces by means of a partition matrix formed by a plurality of partition plates; and
further wherein each of the plurality of measuring cups are marked with a plurality of measurement lines denoting measurements in cups, tablespoons, ounces and millimeters.

2. The storage organizer device of claim 1, wherein the base component comprises a hinged lid.

3. The storage organizer device of claim 2, wherein the base component comprises a pair of handles secured to opposing raised sidewalls.

4. The storage organizer device of claim 3, wherein the base component is comprised of a transparent material.

5. The storage organizer device of claim 1, wherein the plurality of measuring cups are rectangular in shape.

6. The storage organizer device of claim 5, wherein the plurality of measuring cups are comprised of a transparent material.

7. The storage organizer device of claim 6, wherein each of the plurality of measuring cups comprises a pouring spout.

8. The storage organizer device of claim 7, wherein each of the plurality of measuring cups comprise a handle.

9. The storage organizer device of claim 1 further comprising a tablespoon insert holder.

10. The storage organizer device of claim 9, wherein the tablespoon insert holder comprises a removable stand with a plurality of legs for retaining a set of tablespoons.

11. The storage organizer device of claim 1 further comprising a plurality of indicia.

12. A storage organizer device for storing and organizing a plurality of wet and dry ingredients while cooking or baking, the storage organizer device comprising:
a plurality of removable measuring cups;
a tablespoon insert holder; and
a base component comprising a lid and a pair of handles; and
wherein the base component comprises a rectangular shape with raised sidewalls forming a cavity;
wherein the base component further comprises an interior which is partitioned into a plurality of spaces by means of a partition matrix formed by a plurality of partition plates; and
further wherein each of the plurality of removable measuring cups are marked with a plurality of measurement lines denoting measurements in cups, tablespoons, ounces and millimeters.

13. The storage organizer device of claim 12, wherein each of the plurality of removable measuring cups comprises a pouring spout.

14. The storage organizer device of claim 13, wherein each of the plurality of removable measuring cups comprises a handle.

15. The storage organizer device of claim 12 further comprising a plurality of indicia.

16. The storage organizer device of claim 12, wherein the base component is comprised of a transparent material.

17. The storage organizer device of claim 12, wherein each of the plurality of removable measuring cups is rectangular in shape.

18. The storage organizer device of claim 12, wherein each of the plurality of removable measuring cups is manufactured from a transparent material.

19. The storage organizer device of claim 12, wherein the tablespoon insert holder comprises a removable stand with a plurality of legs for retaining a set of tablespoons.

20. A method of storing and organizing a plurality of wet and dry ingredients, the method comprising the following steps:
utilizing a storage organizer device comprising a transparent carrier base component with a hinged lid and side handles for transporting a plurality of measuring cups or tablespoons stored within;
inserting the plurality of wet and dry ingredients into the storage organizer device;
measuring out a desired quantity of the wet and dry ingredients from the storage organizer device when needed, wherein the desired quantity of the wet and dry ingredients is measured out via the plurality of measuring cups or tablespoons;
pouring the desired quantity of the wet and dry ingredients from the plurality of measuring cups or tablespoons into a bowl or other dishware for use;
baking or cooking a food item with the desired quantity of the wet and dry ingredients; and
emptying, washing and reusing the storage organizer device as needed.
